(19) United States
(12) Patent Application Publication
(10) Pub. No.: US 2015/0185531 A1
(43) Pub. Date: Jul. 2, 2015

(54) LIQUID CRYSTAL DISPLAY PANEL, PIXEL STRUCTURE AND DRIVING METHOD THEREOF

(71) Applicant: SHENZHEN CHINA STAR OPTOELECTRONICS TECHNOLOGY CO LTD., Shenzhen, Guangdong (CN)

(72) Inventor: Xiangyang Xu, Shenzhen (CN)

(21) Appl. No.: 14/240,383

(22) PCT Filed: Jan. 20, 2014
(86) PCT No.: PCT/CN2014/070902

§ 371 Date: Jul. 31, 2014

(30) Foreign Application Priority Data
Dec. 31, 2013 (CN) 201310753606.8

(51) Int. Cl. G02F 1/1362

(52) U.S. Cl. CPC G02F 1/13624; G02F 1/136286

(57) ABSTRACT

The present disclosure relates to a liquid crystal display panel, a pixel structure and a driving method. The pixel structure comprise: a plurality of pixel areas formed by configuring a plurality of data lines and a plurality of scanning lines in a staggered manner; a plurality of pixel electrodes each configured on a corresponding pixel area; a plurality of common lines arranged in a manner of corresponding to the scanning lines respectively one by one, and each of the common lines is overlapped and coupled with the pixel electrode on each pixel area formed by the corresponding scanning line to form a storage capacitor; and a plurality of transistors, each of which is electrically connected with the pixel electrode, the scanning lines and the data lines on each pixel area respectively, wherein each common line is independently controlled in a manner of corresponding to each scanning line so as to eliminate the influence of a feed through voltage on a pixel electrode voltage. According to the present disclosure, when the various scanning lines is driven in sequence through second-order driving, a pulse signal with a phase opposite with the phase of the scanning signal is applied on the common line corresponding to each scanning line, so that the influence of the feed through voltage on a pixel electrode voltage can be eliminated. Therefore, the display effect of image quality can be effectively improved.

### FIELD OF THE INVENTION

The present disclosure relates to a liquid crystal display, and particularly relates to a liquid crystal display panel, a pixel structure thereof, and a driving method thereof.

### BACKGROUND OF THE INVENTION

In recent years, as the display becomes thinner and thinner, Liquid Crystal Display (LCDs for short) has been widely used in various electronic products, such as mobile phones, notebook computers, and color televisions.

However, when the panel is driven, a feed through voltage will be generated due to capacitance coupling, and will cause the changes of a display electrode (also called a pixel electrode). There are three main sources for voltage change on the LCD panel, that is, gate driver voltage change, source driver voltage change, and common (Com) voltage change respectively. The one with the greatest influence is the gate driver voltage change, that is, a feed through voltage generated by a parasitic capacitance Cgd.

FIG. 1 is a voltage waveform timing sequence diagram of a Cs on com structure with a common electrode being driven by direct current. The diagram shows the changes of a display electrode voltage 103 due to the influence of the feed through voltage 104. As shown in FIG. 1, reference number 102 represents a gate driver voltage, 101 represents a source driver voltage, 106 represents a previous common voltage, and 107 represents a corrected common voltage, the correction amount 105 of the common voltage being the feed through voltage 104. In the case that the gate line of the Nth frame is open, an upward feed through voltage will be generated and applied onto the display electrode. However, at this moment, due to the fact that the gate line is open, a source driver circuit will start to charge the display electrode. Therefore, even if the initial voltage is not correct (due to the influence of the feed through voltage), the source driver circuit can still charge the display electrode to a correct voltage, so that no substantial influence will occur. However, in the case that the gate line is closed, as the source driver circuit does not charge the display electrode any more, the feed through voltage will be applied to the display electrode through the parasitic capacitance Cgd due to a voltage drop generated when the gate line is closed. Thus, the display electrode voltage will suffer a feed through voltage drop equal to the feed through voltage, which may influence the correctness of grayscale display. Moreover, unlike the feed through voltage in the case that the gate line is open, this feed through voltage will generate an influence for a relatively long time. Since, at this moment, the source driver circuit does not charge/discharge the display electrode any more, the voltage of the display electrode will be influenced until the next voltage of the gate line is open again. Consequently, the influence of the feed through voltage on a display picture can be clearly observed by human eyes. The case with regard to the (N+1)th frame is also in this way.

As the feed through voltage is mainly the reduction of the pixel voltage caused by the change of the gate driver voltage by virtue of parasitic capacitance Cgd when a TFT (thin film transistor) is closed, the feed through voltage always imparts a negative pulling on the pixel voltage, regardless of whether the pixel polarity is positive or negative. Therefore, the influence of the feed through voltage can be reduced by means of compensating the common voltage. However, since the liquid crystal capacitance Clc is not a fixed parameter, the objective of improving image quality by adjusting the common voltage cannot be realized easily.

Therefore, it is desirable to solve the above-mentioned problem so as to provide a driving solution for effectively reducing the influence of a feed through voltage on the display effect of the image quality in the field.

### SUMMARY OF THE INVENTION

One of the technical problems to be solved in the present disclosure is to provide a driving method for a liquid crystal display panel, with which method the influence of a feed through voltage on the display effect of image quality can be effectively reduced. In addition, a pixel structure of the liquid crystal display panel is further provided.

In order to solve the above-mentioned technical problems, the present disclosure provides a pixel structure, comprising: a plurality of pixel areas formed by configuring a plurality of data lines and a plurality of scanning lines in a staggered manner; a plurality of pixel electrodes each configured on a corresponding pixel area; a plurality of common lines arranged in a manner of corresponding to the scanning lines respectively one by one, and each of the common lines is overlapped and coupled with the pixel electrode on each pixel area formed by the corresponding scanning line to form a storage capacitor; and a plurality of transistors, each of which is electrically connected with the pixel electrode, the scanning lines and the data lines on each pixel area respectively, wherein each common line is independently controlled in a manner of corresponding to each scanning line so as to eliminate the influence of a feed through voltage on a pixel electrode voltage.

In an example, each transistor includes a gate, a first source/drain, and a second source/drain, wherein the gate is electrically connected with the scanning lines, the first source/drain is electrically connected with the pixel electrodes, and the second source/drain is electrically connected with the data lines.

According to another aspect of the present disclosure, a liquid crystal display panel is further provided, comprising: a plurality of data lines; a plurality of scanning lines, configured with the data lines in a staggered manner to form a plurality of pixel areas; a plurality of pixel electrodes each configured on a corresponding pixel area; a plurality of common lines arranged in a manner of corresponding to the scanning lines respectively one by one, and each of the common lines is overlapped and coupled with the pixel electrode on each pixel area formed by the corresponding scanning line to form a storage capacitor; and a plurality of transistors, each of which is electrically connected with the pixel electrode, the scanning lines and the data lines on each pixel area respectively, wherein each common line is independently controlled in a manner of corresponding to each scanning line so as to eliminate the influence of a feed through voltage on a pixel electrode voltage.

In an example, each transistor includes a gate, a first source/drain, and a second source/drain, wherein the gate is electrically connected with the scanning lines, the first source/drain is electrically connected with the pixel electrodes, and the second source/drain is electrically connected with the data lines.

In an example, the liquid crystal display panel is a twisted nematic liquid crystal display panel.

In an example, the liquid crystal display panel is a vertical alignment liquid crystal display panel.

According to a further aspect of the present disclosure, a driving method for a liquid crystal display panel is further provided, wherein the display panel comprises a plurality of data lines, a plurality of scanning lines, pixel electrodes configured on pixel areas formed by configuring the data lines and the scanning lines in a staggered manner respectively, a plurality of common lines arranged by being corresponding to the scanning lines respectively one by one, each of which is overlapped and coupled with the pixel electrode on each pixel area formed by the corresponding scanning lines to form a storage capacitor, and a plurality of transistors electrically connected with the pixel electrode on each pixel area, the scanning lines and the data lines respectively, and the method comprises: performing second-order driving on the various scanning lines in sequence, and in the case that a scanning signal is provided to drive the various scanning lines in sequence, applying a pulse signal with a phase opposite to the phase of the scanning signal on the common line corresponding to each scanning line to reduce or increase a set voltage value, so as to eliminate the influence of the feed through voltage on a pixel electrode voltage.

In an example, the set voltage value is set according to the following expression:

V=(Vg_high−Vg_low)*Cgd/Cs,

wherein Vg_high and Vg_low are the opening voltage and the closing voltage of the scanning lines respectively, and set according to the characteristic curve of the transistors in the display panel, Cgd is the parasitic capacitance of the transistors, and Cs is storage capacitor.

Compared with the prior art, one or more examples of the present disclosure can bring about the following advantages. According to the present disclosure, when the various scanning lines is driven in sequence through second-order driving, a pulse signal with a phase opposite with the phase of the scanning signal is applied on the common line corresponding to each scanning line, so that the influence of the feed through voltage on a pixel electrode voltage can be eliminated. Therefore, the display effect of image quality can be effectively improved.

Other features and advantages of the present disclosure will be illustrated in the following description, and are partially obvious from the description or understood through implementing the present disclosure. The objectives and other advantages of the present disclosure may be realized and obtained through the structures specified in the description, claims and accompanying drawings.

### BRIEF DESCRIPTION OF THE DRAWINGS

The accompanying drawings, which are provided for further understanding the present disclosure, constitute a part of the description, and are used for interpreting the present disclosure together with the examples of the present disclosure, rather than limiting the present disclosure. In the accompanying drawings:

FIG. 1 shows a voltage fluctuation timing sequence diagram in a structure in which the storage capacitor framework is Cs on Com and the common voltage thereof is driven by direct current in the prior art;

FIG. 2 schematically shows the structure of a display panel according to an example of the present disclosure;

FIG. 3 schematically shows the structure of a pixel structure in a TFT substrate according to an example of the present disclosure;

FIG. 4 schematically shows the structure of a pixel structure in a TFT substrate according to another example of the present disclosure;

FIG. 5 shows a second-order driving timing sequence diagram for common voltage in a driving method for a liquid crystal display panel according to the present disclosure; and

FIG. 6 shows a voltage fluctuation timing sequence diagram in a structure in which the storage capacitor framework is Cs on Com and the common voltage thereof is driven by direct current in the case that the driving method for a liquid crystal display panel according to the present disclosure is used.

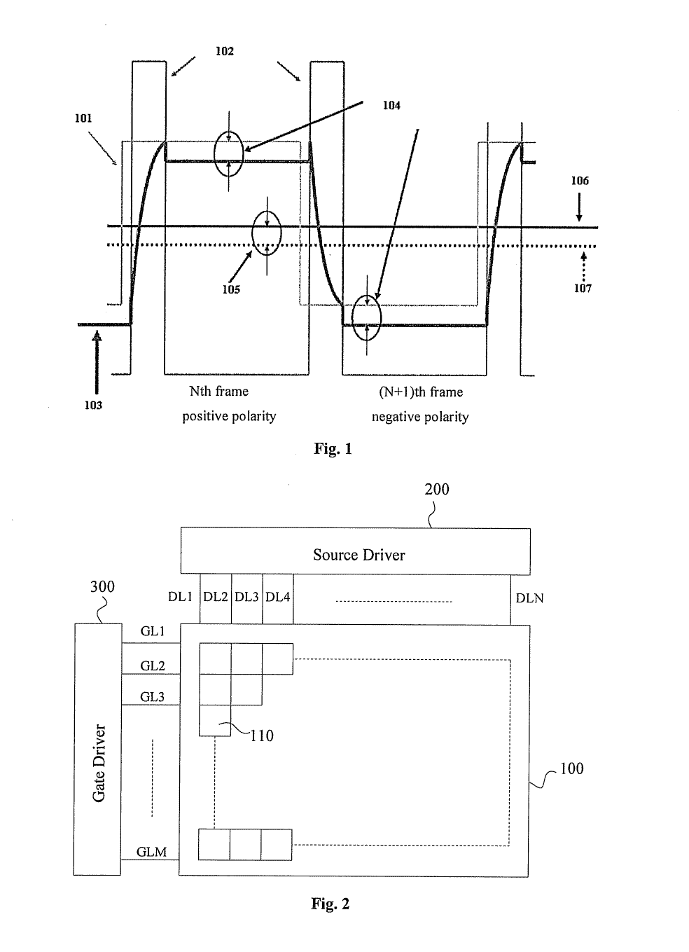

### DETAILED DESCRIPTION OF THE EMBODIMENTS

To make the objectives, technical solutions and advantages of the present disclosure clearer, the present disclosure will be further illustrated in detail below in conjunction with the accompanying drawings.

Referring to FIG. 2, it schematically shows the structure of a display panel according to an example of the present disclosure. The display panel includes an image display area 100, a source driver 200, and a gate driver 300. The image display area 100 includes an array formed by configuring a plurality of data lines (also referred to as information lines; N data lines DL1-DLN are shown in the figure) and a plurality of scanning lines (also referred to as gate lines; M scanning lines GL1-GLM are shown in the figure) in a staggered manner, and a plurality of pixel structures 110. The source driver 200 transmits the data signals provided into the image display area 100 through the plurality of data lines coupled with the source driver 200. The gate driver 300 transmits the scan signals provided into the image display area 100 through the plurality of scan lines coupled with the gate driver 300.

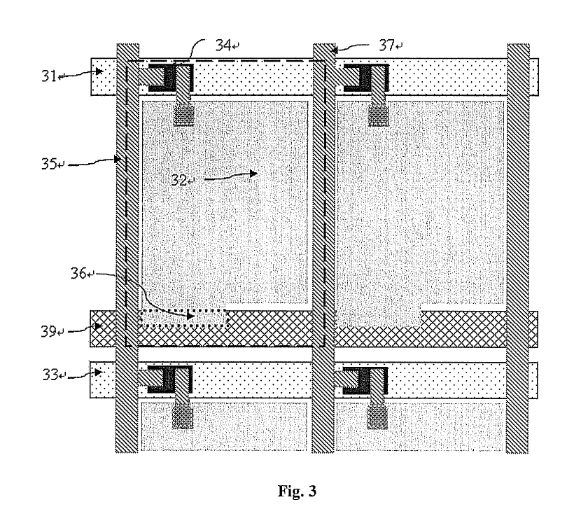

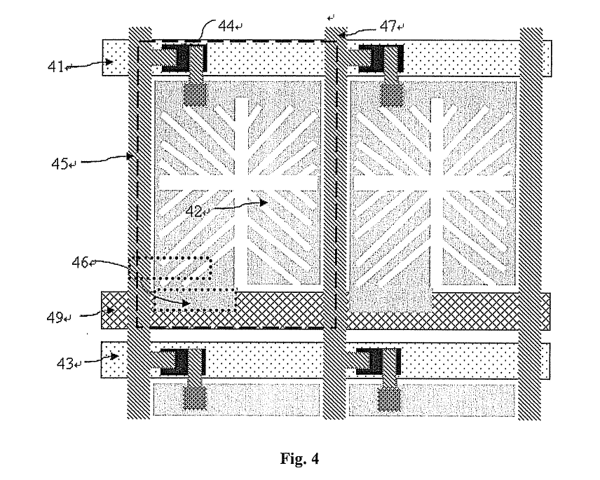

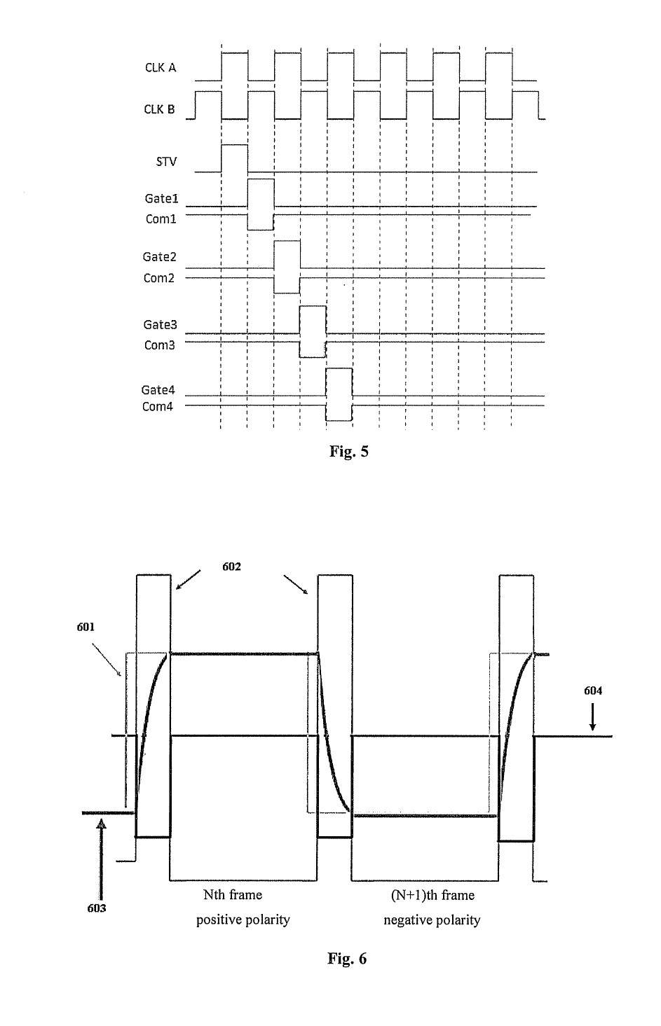

FIG. 3 and FIG. 4 show the pixel structures of a twisted nematic (TN) liquid crystal display panel and a vertical alignment (VA) liquid crystal display panel respectively, the scanning lines of the pixel structures being subjected to a second-order driving, and each common line being independently controlled. The specific driving timing sequence is shown in FIG. 5.

FIG. 3 schematically shows the structure of a pixel structure in a TFT substrate according to an example of the present disclosure. As shown in FIG. 3, the pixel structure is in a mode of Cs on com. The pixel structure comprises: a plurality of pixel areas; a plurality of pixel electrodes each configured on a corresponding pixel area; a plurality of common lines, which are arranged relative to the scanning lines in one-to-one correspondence, respectively, each of the common lines being overlapped and coupled with the pixel electrode of each pixel area comprising the corresponding scanning line so as to form a storage capacitor; and a plurality of transistors, each of which is electrically connected with the pixel electrode, the scanning lines and the data lines of each pixel area respectively.

For convenience, only two complete pixel areas are shown in FIG. 3. Taking the pixel area on the left as an example, the portion surrounded by dotted lines is the area of a pixel. The pixel area is formed by configuring a scanning line 31, a scanning line 33, a data line 35 and a data line 37 in a staggered manner. A pixel electrode 32 is configured in the pixel area. A common line 39 is provided corresponding to the scanning line 31, and is further overlapped and coupled with the pixel electrode 32 to form a storage capacitor (Cs) 36. A transistor 34 is electrically connected with the pixel electrode 32, the scanning line 31 and the data line 35. The transistor 34 is preferably a thin film transistor (TFT), comprising a gate, a drain and a source, wherein the gate is electrically connected with the scanning line 31, the drain is electrically connected with the pixel electrode 32, and the source is electrically connected with the data line 35.

FIG. 4 schematically shows the structure of a pixel structure in a TFT substrate according to another example of the present disclosure. As shown in FIG. 4, for convenience, only two complete pixel areas are shown. Taking a pixel area on the left as an example, the portion surrounded by dotted lines is the area of a pixel. The pixel area is formed by configuring a scanning line 41, a scanning line 43, a data line 45 and a data line 47 in a staggered manner. A pixel electrode 42 is configured in the pixel area. A common line 49 is provided corresponding to the scanning line 41, and is further overlapped and coupled with the pixel electrode 42 to form a storage capacitor (Cs) 46. A transistor 44 is electrically connected with the pixel electrode 42, the scanning line 41 and the data line 45. The transistor 44 is preferably a thin film transistor (TFT), comprising a gate, a drain and a source, wherein the gate is electrically connected with the scanning line 41, the drain is electrically connected with the pixel electrode 32, and the source is electrically connected with the data line 45.

It should be noted that, in the above-mentioned pixel structures, each common line corresponding to a respective scanning line is independently controlled. That is, each common line of the liquid crystal display panel is controlled by a respective voltage signal, instead of by a uniform voltage signal as in the prior art. With regard to the common line 39 in FIG. 3, it is controlled in a manner of corresponding to the scanning line 31.

In the following the method of how to independently control the common line will be illustrated in detail.

As shown in FIG. 5, two timing sequences Clk A, Clk B with identical period but opposite polarities are adopted. It can be seen that, common lines Com1, Com2, Com3 and Com4 are arranged in a manner of corresponding to scanning lines Gate1, Gate2, Gate3 and Gate4 respectively. In the case that different scanning signals are provided for performing second-order driving on the various scanning lines in sequence, a pulse signal with a phase opposite with that of the scanning signal is also provided for the corresponding common line, so that a set voltage value can be reduced or increased. Thus the influence of the feed through voltage can be completely eliminated.

The set voltage value to be reduced or increased can be determined by the following expression:

V=Vcom_high−Vcom_low =(Vg_high−Vg_low)*Cgd/Cs

wherein, Vg_high and Vg_low are set according to the characteristic curve of TFT, Cgd is the parasitic capacitance of the TFT, Cs is the storage capacitance, Vcom_high is the high level of the common voltage which is set according to a liquid crystal driving voltage, and Vcom_low=Vcom_high−(Vg_high−Vg_low)*Cgd/Cs, from which it can be seen that Vcom_low is dependent on the liquid crystal driving common voltage, a TFT driving switch voltage, the TFT parasitic capacitance, and the pixel storage capacitance.

This is due to the fact that, when second-order driving is performed on the pixels shown in FIG. 3 or FIG. 4 as mentioned above, a feed through voltage generated by the parasitic capacitance Cgd and the feed through voltage generated by the storage capacitance Cs are formed. Moreover, the feed through voltage generated by the parasitic capacitance Cgd can be expressed as (Vg_high−Vg_low)*Cgd/(Cgd+Clc+Cs), wherein Vg_high and Vg_low are voltages when gate lines (scanning lines) are opened and closed respectively. The feed through voltage generated by the storage capacitance Cs can be expressed as (Vcom_high−Vcom_low)*Cs/(Cgd+Clc+Cs), wherein Vcom_high and Vcom_low are the high potential and the low potential of common lines respectively. In order to enable the two feed through voltages to be mutually counteracted, the feed through voltage generated by the parasitic capacitance Cgd needs to be equal to the feed through voltage generated by the storage capacitance Cs. Therefore, the above-mentioned expression is obtained.

FIG. 6 shows the specific effect obtained according to the present disclosure. It can be seen that, with regard to the Nth frame and the (N+1)th frame, a display electrode voltage 603 without being influenced by the feed through voltage is obtained under the actions of a source driving voltage 601, a gate driving voltage 602, and a common voltage 604.

The driving method is a novel second-order driving method, with which the influence of the feed through voltage on a display voltage can be eliminated.

In conclusion, by independently controlling each common line of pixels, that is, driving the common ends of the storage electrodes by a pulse with a phase opposite with the phase of the second-order voltage of the scanning lines, the influence of the feed through voltage can be thoroughly eliminated. Consequently, the displayed picture will have an excellent effect.

The foregoing descriptions are merely preferred specific embodiments of the present disclosure, but the protection scope of the present disclosure is not limited thereto. Readily conceivable variations or substitutions, to any skilled one who is familiar with this art, within the disclosed technical scope of the present disclosure shall be incorporated in the protection scope of the present disclosure. Accordingly, the protection scope of the claims should be subjected to the protection scope of the present disclosure.

1. A pixel structure, comprising:
a plurality of pixel areas formed by configuring a plurality of data lines and a plurality of scanning lines in a staggered manner;
a plurality of pixel electrodes, each configured on a corresponding pixel area;
a plurality of common lines, which are arranged relative to the scanning lines in one-to-one correspondence respectively, each of the common lines being overlapped and coupled with the pixel electrode of each pixel area comprising the corresponding scanning line so as to form a storage capacitor; and
a plurality of transistors, each of which is electrically connected with the pixel electrode, the scanning lines and the data lines on each pixel area respectively,
wherein each common line is independently controlled in a manner of corresponding to a respective scanning line, so as to eliminate the influence of a feed through voltage on a pixel electrode voltage.

2. The pixel structure according to claim 1, wherein each transistor includes a gate, a drain and a source, and
the gate is electrically connected with the scanning lines, the drain is electrically connected with the pixel electrodes, and the source is electrically connected with the data lines.

3. A liquid crystal display panel, comprising:
a plurality of data lines;
a plurality of scanning lines, which form a plurality of pixel areas respectively with the plurality of data lines in a staggered manner;
a plurality of pixel electrodes, each configured on a corresponding pixel area;
a plurality of common lines, which are arranged relative to the scanning lines in one-to-one correspondence respectively, each of the common lines being overlapped and coupled with the pixel electrode of each pixel area comprising the corresponding scanning line so as to form a storage capacitor; and
a plurality of transistors, each of which is electrically connected with the pixel electrode, the scanning lines and the data lines on each pixel area respectively,
wherein each common line corresponding to a respective scanning line is independently controlled so as to eliminate the influence of a feed through voltage on a pixel electrode voltage.

4. The pixel structure according to claim 3, wherein each transistor includes a gate, a drain and a source, and
the gate is electrically connected with the scanning lines, the drain is electrically connected with the pixel electrodes, and the source is electrically connected with the data lines.

5. The liquid crystal display panel according to claim 3, wherein the liquid crystal display panel is a twisted nematic liquid crystal display panel.

6. The liquid crystal display panel according to claim 4, wherein the liquid crystal display panel is a twisted nematic liquid crystal display panel.

7. The liquid crystal display panel according to claim 3, wherein the liquid crystal display panel is a vertical alignment liquid crystal display panel.

8. The liquid crystal display panel according to claim 4, wherein the liquid crystal display panel is a vertical alignment liquid crystal display panel.

9. A driving method for a liquid crystal display panel,
the display panel comprising:
a plurality of data lines,
a plurality of scanning lines,
a pixel electrode configured on each of pixel areas formed by configuring the data lines and the scanning lines in a staggered manner respectively,
a plurality of common lines, which are arranged relative to the scanning lines in one-to-one correspondence respectively, each of the common lines being overlapped and coupled with the pixel electrode of each pixel area comprising the corresponding scanning line so as to form a storage capacitor; and
a plurality of transistors electrically connected with the pixel electrode on each pixel area, the scanning lines and the data lines respectively,
wherein the method comprises:
performing a second-order driving for each of the scanning lines in sequence, and
when a scanning signal are provided to drive a respective scanning line in sequence, applying a pulse signal with a phase opposite to the phase of the scanning signal on the common line corresponding to a respective scanning line to reduce or increase a set voltage value, so as to eliminate the influence of the feed through voltage on a pixel electrode voltage.

10. The driving method according to claim 9, wherein the set voltage value is determined according to the following expression:
V=(Vg_high−Vg_low)*Cgd/Cs,
in which Vg_high and Vg_low are the opening voltage and the closing voltage of the scanning lines respectively, and are determined according to the characteristic curve of the transistors in the display panel, Cgd is the parasitic capacitance of the transistors, and Cs is storage capacitor.
